(19) United States
(12) Patent Application Publication
(10) Pub. No.: US 2014/0160256 A1
(43) Pub. Date: Jun. 12, 2014

(54) APPARATUS AND TECHNIQUES TO PROVIDE VARIABLE DEPTH DISPLAY

(71) Applicants: Daniel Avrahami, Mountain View, CA (US); Maria Pitallano, San Francisco, CA (US)

(72) Inventors: Daniel Avrahami, Mountain View, CA (US); Maria Pitallano, San Francisco, CA (US)

(21) Appl. No.: 13/710,369

(22) Filed: Dec. 10, 2012

(51) Int. Cl. H04N 13/04

(52) U.S. Cl. CPC H04N 13/04
USPC 348/51

(57) ABSTRACT

A device may include a processor circuit and a screen depth modifier component for execution on the processor circuit to vary an image displacement between a first image and second image for presentation simultaneously with the first image, the image displacement varying from a first image displacement to a second image displacement different from the first image displacement. Other embodiments are disclosed and claimed.

### BACKGROUND

In the present day, in workplace, home, and other settings, users often spend time in front of a display screen causing their eyes to remain focused on the display in an uninterrupted fashion for long periods of time. This may cause degradation in the user's experience while performing work tasks or other activity. The so-called Computer Vision Syndrome has been used to describe a condition resulting from such uninterrupted viewing of a display. Symptoms associated with Computer Vision Syndrome (CVS) include headaches, blurred vision, double vision, neck pain, reddening of eyes, fatigue, eyestrain, dry eyes, polyopia, and difficulty refocusing eyes.

One of the causes of CVS is believed to be the continuous focus of eyes at the same distance for an extended period of time. One guideline suggested by doctors to address potential problems with extended viewing of displays, is the so-called 20/20/20 rule, which denotes the practice of focusing on an object 20 feet away for twenty seconds at regular intervals of 20 minutes. Particular solutions to CVS address different aspects of CVS. In one example, an application may be deployed to remind a user to employ the 20/20/20 rule, for example, by issuing alerts every 20 minutes. Other examples include special “computer” glasses fit for a typical viewing distance of 20 to 26 inches from a display surface, and applications that display a blinking eye to encourage eye blinking, the latter of which may reduce redness and dryness of the eyes.

However, each of the above solutions places a burden on the user, either to adopt special equipment, or to acknowledge what may be considered to be obtrusive reminders, and/or to periodically interrupt attention or activity that may be performed with a display device to perform certain tasks.

Accordingly, there may be a need for improved techniques and apparatus to solve these and other problems.

### BRIEF DESCRIPTION OF THE DRAWINGS

FIG. 1 illustrates a block diagram for an exemplary apparatus.

FIG. 2A depicts exemplary operation of an apparatus according to the present embodiments.

FIG. 2B depicts further exemplary operation of the apparatus of FIG. 2A.

FIG. 2C depicts further exemplary operation of the apparatus of FIGS. 2A and 2B.

FIG. 3A depicts details of operation of an exemplary apparatus.

FIG. 3B depicts further details of operation of the exemplary apparatus of

FIG. 3A.

FIG. 3C depicts further details of operation of the exemplary apparatus of FIG. 3A.

FIG. 4 depicts details of an exemplary apparatus.

FIG. 5 depicts an exemplary image displacement curve.

FIG. 6 depicts another exemplary image displacement curve.

FIG. 7A depicts another exemplary image displacement curve.

FIG. 7B depicts a further exemplary image displacement curve.

FIG. 8A presents one embodiment of a menu.

FIG. 8B presents another embodiment of a menu.

FIG. 9A depicts embodiment non-displaced image.

FIG. 9B depicts displacement of the image of FIG. 9A.

FIG. 9C depicts operation of another embodiment.

FIG. 9D depicts further operation of the embodiment of FIG. 9C.

FIG. 10 presents an exemplary first logic flow.

FIG. 11 presents an exemplary second logic flow.

FIG. 12 presents an exemplary third logic flow.

FIG. 13 is a diagram of an exemplary system embodiment.

### DETAILED DESCRIPTION

Various embodiments are directed to techniques for enhancing the user experience for viewing an electronic display, such as a display of a computing device, communications device, entertainment device, or hybrid device. In particular, various embodiments employ a stereoscopic or three dimensional (3-D) display to generate a set of images in which the distance between a visual interface of the display and a stationary user appears to move as a function of time. In various embodiments techniques and devices (apparatus) are provided to generate gradual, global, and typically unnoticeable changes to the depth of all elements presented on a stereoscopic display in a manner that causes a user's eyes to focus at varying distances over time.

The present embodiments may be employed with stereoscopic displays that employ glasses, such as eclipse systems, polarizing systems, interference filtering systems, and autosteroscopic displays. The embodiments are not limited in this context. In various embodiments, a stereoscopic display device may present a display interface that appears two dimensional in other respects, but whose apparent screen depth varies with time. The term “screen depth” as used herein refers to a distance between a plane of the user's eyes and the apparent position of the plane of an image presented on a stereographic screen (display) surface when the screen is viewed in a stereoscopic manner. The term “stereoscopic manner” refers to use of necessary apparatus to generate stereoscopic images to a user. For autostereoscopic displays, no extra equipment is generally required to view the display screen in a stereoscopic manner other than the display screen itself. On the other hand, systems based upon the use of glasses by nature requires that the user be wearing glasses to view the display screen in a stereoscopic manner.

Thus, the present embodiments generate to the user's eyes stereoscopic images of a display screen that require the user to vary focus in order to clearly perceive elements in the screen surface, such as objects, text, or other screen elements. Although in some embodiments, an entire display screen may be perceived as a flat 2-dimensional surface, in other embodiments individual elements in an image may be perceived as three dimensional objects. In such embodiments, the entire display interface may be perceived, in some cases in an unconscious manner, as moving away from a user and/or towards the user, while individual elements retain a 3-D quality such that the individual elements appear to extend above or below other portions of an image presented by the display.

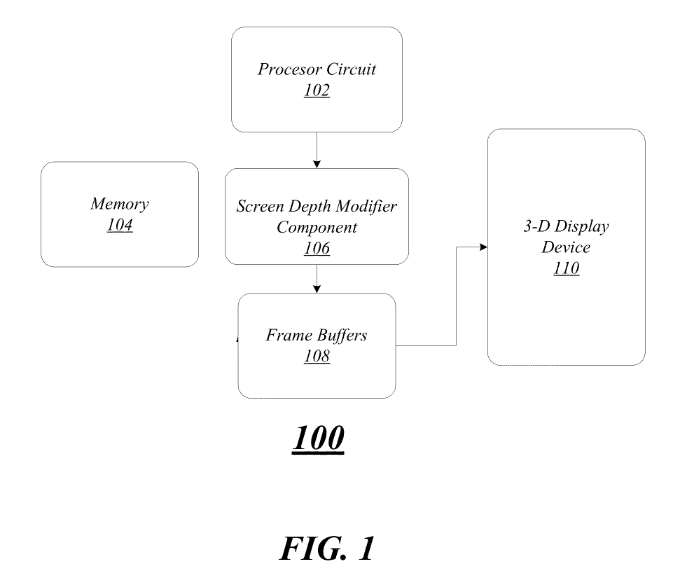

In various embodiments, a screen depth modifier component may be interoperative with a hardware component, such as a central processor unit, or other logic to vary screen depth of a stereoscopic display. FIG. 1 depicts one example of a device or apparatus 100 consistent with the present embodiments. The apparatus 100 of FIG. 1 may be embodied, for example, in a desktop computer, a mobile device such as a laptop computer, tablet computing device, smart phone or other electronic computing device or communications device, a television (TV), or videogame device. The embodiments are not limited in this context.

The apparatus 100 may be used in particular for presenting visual content to a user in a manner in which the distance between a stationary user and an apparent position of the display interface, a so-called screen depth, is perceived to move over time. The apparatus 100 includes a processor circuit 102, memory 104, screen depth modifier component 106, frame buffers 108 and 3-D display device 110. In various embodiments, the 3-D display device is operative to modify images presented on the 3-D display device 110 in a manner that changes displacement between successive sets of images presented on the 3-D display device 110. This results in a change in the screen depth that may cause a user to adjust eye focus to properly perceive visual content on the 3-D display device 110.

In particular, in various embodiments the processor circuit 102 and/or screen depth modifier component 106 may include various hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

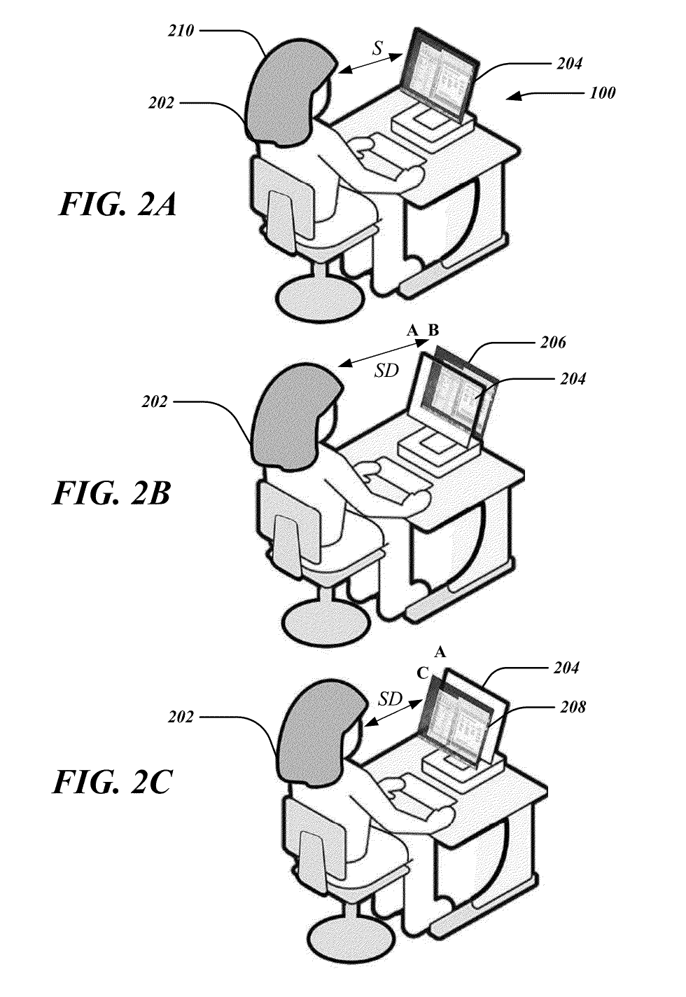

Turning now to FIGS. 2A to 2C there is shown one example of operation of the present embodiments. In this example, a user 202 is seated in front of a display screen 204, which may be part of a desktop computer or laptop computer in some instances. Consistent with the present embodiments, the display screen 204 may be a stereoscopic display that can generate two different images to be perceived separately by the user 202. In the scenario depicted in FIGS. 2A to 2C, the user 202 and display screen 204 are depicted at three different instances in time. The user 202 may be generally stationary and the display screen 204 may also be generally stationary such that the distance or separation S between the head 210 of the user 202 and display screen 204 remains the same at the instances depicted in each of the FIGS. 2A, 2B, and 2C. Thus, the user behavior example of FIGS. 2A-2C illustrates a common situation in which the user may remain in front of a display at a fixed distance for extended periods of time.

In the specific scenario of FIG. 2A, the present embodiments operate to deliver images onto the display screen 204 that cause the user 202 to perceive the screen depth to be at the actual distance (separation S) that separates the user from the display screen 204. This may be accomplished by generating identical images each occupying the same portion of the display screen 204 as discussed further below. In the specific example illustrated in FIG. 2A a word-processing application may be presented in a manner that covers the display screen 204. Accordingly, at the instance depicted in FIG. 2A the word processing application and entire display screen 204 may present a two-dimensional (2-D) image that is perceived to lie in the plane of the actual display screen 204.

Consistent with the present embodiments, the screen depth modifier component 106 may cause a displacement to take place between a “left” image delivered to the left eye of the user 202 and “right” image delivered to the right eye of the user 202. In various embodiments, and as discussed in more detail below, the displacement between left image and right image may increase to a preset amount according to a preset function. When a displacement is generated between left image and right image and as the displacement changes, the position of the screen image 206 may appear to change. After a period of time has elapsed, this displacement between left and right images may result in the generation of a screen image 206 that appears to lie a certain distance behind the plane of the display screen 204, as shown in FIG. 2B.

Thus, the present embodiments act to vary the perceived distance between the eyes of user 202 and the image of the display screen 204, what is referred to herein as screen depth, although the actual distance between the eyes of user 202 and the display screen 204 may not vary. It is to be noted that the screen depth modifier component 106 may regulate the rate of movement of the screen depth so that the change in screen depth is not consciously noticeable to the user. For example, the screen depth SD may vary between the points A and B illustrated in FIG. 2B over a period of tens of seconds to hundreds of seconds.

In this manner, a gradual change of screen depth SD may be consciously unnoticeable to a user 202, which may result from a phenomenon known as “change blindness.” If SD is varied too rapidly, the user 202 may notice the apparent change in position of screen image 206. However, if the rate of change of SD is more gradual, the change in the position of screen image 206 may not be consciously noticed by the user.

It is to be noted that although the user 202 may not consciously recognize shifts in the screen image 206, the user's eyes may adjust between the instance depicted in FIG. 2A and the instance depicted in FIG. 2B in order to focus properly on content that appears to lie in the plane of screen image 206 at the time of FIG. 2B, without the user taking conscious notice of such adjustments. In this manner, the user's eyes are stimulated to vary the focal distance, without necessarily being noted by the user 202. This may act to reduce the CVS and other related problems that may result from extended continuous focus on a display screen at an unvarying distance.

Subsequent to the instance depicted in FIG. 2B, the SD may be reduced such that the SD and S coincide once more as in conventional viewing in which the plane of the image perceived by a user viewing a display screen coincides with the physical location of the display screen. In a further instance the value of SD may be decreased from that shown in FIG. 2A, such that a screen image appears to the user 202 to be located in front of the display screen 204, that is, closer to the user 202. This situation is depicted in the scenario of FIG. 2C, which shows a screen image 208 at point C that is at a closer distance (smaller value of SD) to the user 202 as compared to the scenario in FIGS. 2A and 2B. The screen depth may subsequently increase so that the scenario of FIG. 2A is reproduced in which screen image and the display screen are at the same distance from the user 202.

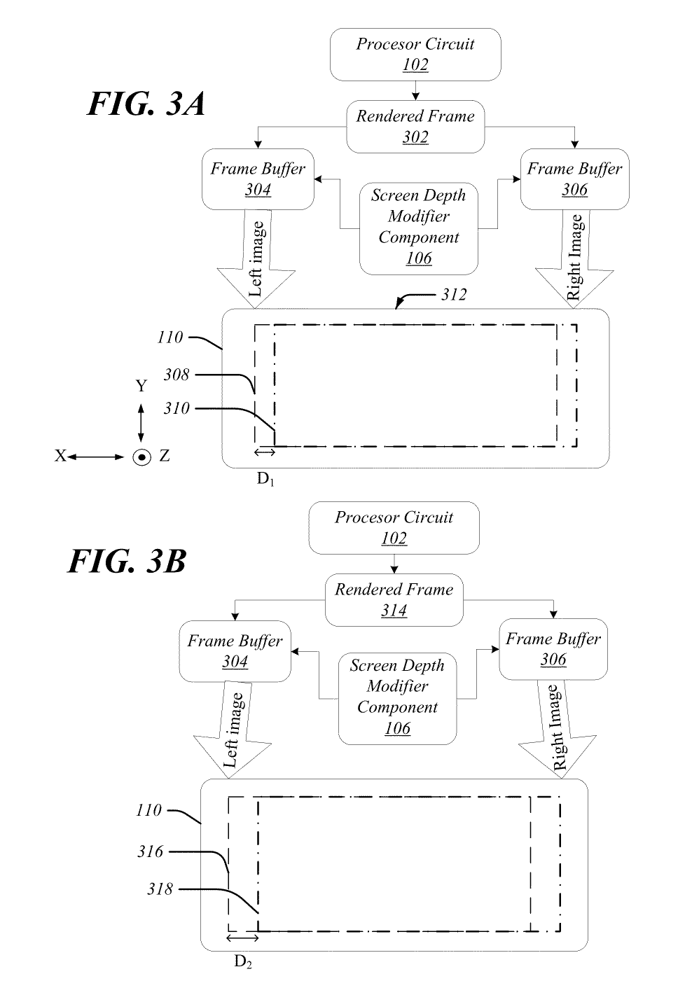

FIGS. 3A and 3B depict operation of a screen depth modifier component 106 that illustrates features of image displacement for varying the screen depth in accordance with various embodiments. In FIG. 3A there is shown the generation of a rendered frame 302 at a first instance. The rendered frame 302 may be generated by a processor circuit 102, which may be a graphics processor in some embodiments. The rendered frame 102 is forwarded to a first frame buffer 304 and second frame buffer 306 for generation of a screen image on the 3-D display device 110. The screen depth modifier component 106 may then direct first frame buffer 304 and second frame buffer 306 to forward the rendered frame 302 for display as left image 308 and right image 310 on the 3-D display device 110. The left image 308 and right image 310 may be generated simultaneously so that a user perceives a single image composed of the left and right images. The term “simultaneously,” as used herein in the context of generation of left and right images, refers to the provision of separate left and right images on a display for a given data frame that alternate between one another. Thus, a rendered graphics frame may generate content that is first presented as first visual frame or left image, and immediately thereafter presented as a second visual frame or right image, where the interval between presentation of left and right images is typically less than about one tenth second. In this manner, a user perceives a single image that is derived from the same rendered frame presented “simultaneously” as left and right images. As illustrated in the example of FIG. 3A, the left image 308 is displaced from the right image 310 by a distance D₁.

In operation, a user viewing the display device 110 when the rendered frame 302 is presented receives two different images: left image 308 is received by the left eye and right image 310 is received by the right eye. In one example in which viewing glasses (not shown) are used to view the 3-D display device 110, the right eyepiece may be blanked when the left image 308 is displayed on the 3-D display device and the left eyepiece may be blanked when the right image 310 is presented. As noted, the switching between presentation of left image 308 and right image 310 may take place in a manner and rate generally in accordance with known techniques such that the user viewing the 3-D display device 110 perceives a single image. However, because the left image is displaced by a distance D₁ from the right image, the resulting image of the 3-D display device 110 may appear to be closer or further away from the user than that of the actual 3-D display device screen. In the particular scenario of FIG. 3A, the relative leftward displacement of the left image 308 and rightward displacement of the right image 310 from one another with respect to a condition of complete coincidence of the left and right images acts to create a 3-D image that appears closer to a viewer than a non-3-D image of the same rendered graphics frame. In other scenarios, such as that shown in FIG. 3C, a relative rightward displacement of a left image 326 and leftward displacement of a right image 328 from one another with respect to a condition of complete coincidence of the left and right images acts to create a 3-D image that appears further from the viewer.

It is to be noted that the displacement of left image 308 from right image 310 may take place by presenting the contents of the rendered frame 302 on a different set of pixels on the 3-D display device 110 for left image 308 as compared to the set of pixels used to present the right image 310. Consistent with the present embodiments, the displacement D₁ may represent a displacement generally along a direction parallel to the edge 312 of the 3-D display device 110. Thus, for an X-Y pixel coordinate system shown in FIG. 3A in which the X-axis lies parallel to the edge 312, the displacement D₁ may represent a shift in pixels solely along the X-direction, that is, a direction parallel to the X-axis. The center of left image 308 may be displaced by 10 pixels from the center of right image 310 in one example.

Turning now to FIG. 3B, there is shown another instance in which the processor circuit 102 generates another rendered frame 314. The screen depth modifier component 106 may then direct first frame buffer 304 and second frame buffer 306 to forward the rendered frame 314 for display as left image 316 and right image 318 on the 3-D display device 110. As illustrated in FIG. 3B, the left image 308 is displaced from the right image 310 by a distance represented by displacement D₂. As suggested in FIG. 3B, the distance D₂ may represent a greater value than that of displacement D₁. Because the left image is displaced by the displacement D₂ from the right image, which may be greater than the displacement D₁ the resulting image of the 3-D display device 110 may appear to be a greater distance from the actual 3-D display device screen than in the example of FIG. 3A, in this case closer to the viewer.

In the manner generally illustrated by FIGS. 3A and 3B, the screen depth modifier component 106 may vary the screen depth of the 3-D display device 110 so that a user's eyes are relieved from the effects of extended focus on a screen at a fixed distance, including the effects associated with the so-called CVS. As noted above, because the displacement between images may take place in a gradual manner, the user may not consciously perceive any change between different instances, such as those shown in FIGS. 3A and 3B.

In some embodiments, the variation in screen depth may be such that the perceived screen distance remains within a limited range. For example, a user whose eyes are positioned at 50 cm from the surface of a 3-D display screen, the range of apparent screen movement generated by the screen depth modifier component 106 may correspond to a screen depth of 48 to 52 cm in one example. However, the range of variation of screen depth may be greater or lesser than this range in other examples.

It is to be noted that the range of apparent screen movement may vary according to the size of a 3-D display screen. Thus, while a 50 cm-diagonal desktop computer screen may be designed to provide a screen depth variation of 4 cm, a 10 cm-diagonal smartphone computer screen may be designed to provide a screen depth variation of 1 cm.

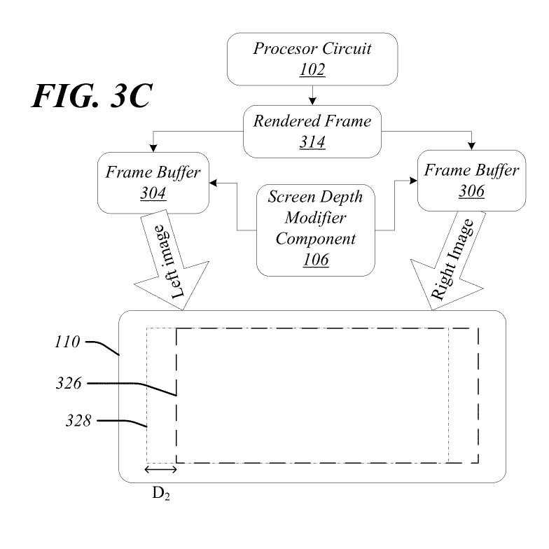

Because individual characteristics of users may vary, both in physical vision characteristics and in psychological perception, the variation of screen depth may be tailored as desired. FIG. 4 presents details of one embodiment of the screen depth modifier component 106. In this example, the screen depth modifier component 106 includes an activation component 402, a screen depth range selection component 404, and screen depth speed component 406, and custom screen depth component 408. The activation component 402 may provide a mechanism that allows a user to manually activate the operation of the screen depth modifier component 106, as discussed further below. The screen depth range component 106 may be operative to vary the screen depth range that is traversed when the screen depth modifier component 106 is active. In one example, a selection interface may be provided to a user of the apparatus 100, such as a menu that allows a user to select modification of the screen depth range and to set the desired screen depth range. This may be useful to adjust settings when an apparatus 100 is to be employed by a user for the first time, and when the apparatus 100 is to be used by multiple users whose vision characteristics may vary.

The screen depth speed component 406 may be operative to vary the rate at which the screen depth varies when the screen depth modifier component 106 is active. Again, in various embodiments this aspect of the screen depth modification may be user-configurable. This allows for adjusting to individual differences in vision characteristics and/or psychological perception. For example, a first user may tolerate or prefer a more rapid change in screen depth to relieve eyestrain than a second user, who may benefit from a slower change in screen depth. Moreover, the threshold in speed of changing screen depth at which the screen depth is consciously perceived may vary among users. As noted above, the conscious perception of changes in screen depth may be undesirable or not tolerable to a user. Accordingly, in some embodiments, the speed of changing screen depth may be manually adjustable using the screen depth speed component 406.

The custom screen depth component 408 may provide the ability to customize the variation in screen depth so that a user experience can be optimized. In one example, custom screen depth component 408 may provide to a user multiple variable parameters including those described above with respect to components 404, 406, so that a user can alter the pattern of screen depth variation and determine an ideal pattern for that user.

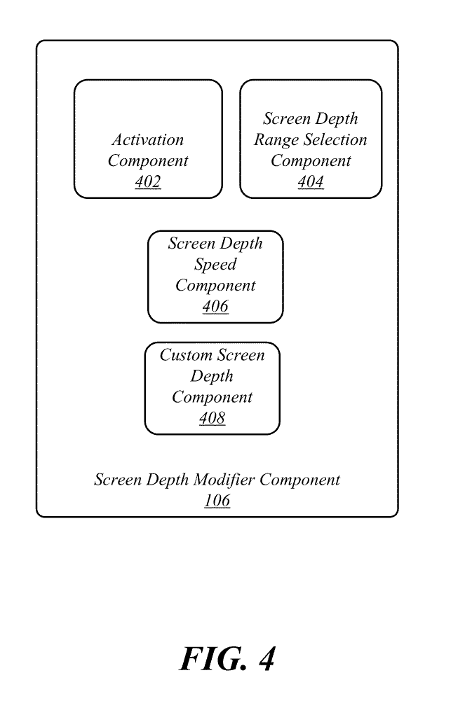

FIG. 5 depicts an exemplary image displacement curve 502 consistent with the present embodiments. The image displacement curve 502 represents the variation of image displacement D as a function of time. As illustrated, initially the image displacement between left and right images is equal to zero. In this situation, the screen image position of a 3-D display coincides with the physical location of the display screen to present the image, as suggested in the insert image 504. The image displacement curve 502 describes a generally smooth variation in D, in which the value of D oscillates between increasing in relative value in a first direction (+), decreasing in value along the first direction until a zero value of D is reached, increasing in value in a second direction (−) that is opposite the first direction, and decreasing in value in the second direction.

In some embodiments, the period P of a cycle of oscillation of D may be set by a user. Considerations in setting a general value P include the ability of a user to consciously discern changes in the screen depth, as well as the efficacy of relieving or preventing CVS. Likewise, in some embodiments, the value of the maximum amplitude A of change in D may be set by a user, which is proportional to the amount of change in screen depth.

For convenience of illustration, the convention adopted in FIG. 5 is that a “positive” value of D indicates the situation in which a left image is displaced outwardly toward the left and right image outwardly toward the right with respect to an image in which the left and right images are exactly superimposed. Referring also to FIG. 3A, this positive displacement may be represented by a relative shift of images parallel to the X-axis. Accordingly, a “negative” value of D indicates that a left image is shifted rightwardly and right image shifted leftwardly with respect to the situation where the two images are superimposed. As suggested by FIG. 5, when D is positive (see insert 506), the screen depth decreases and when D is negative (see insert 508) the screen depth increases.

Thus, the oscillation shown in curve 502 may correspond to the relative displacement of left images and right images generally shown in FIGS. 3A to 3C in the following manner. When D is equal to “0” the left image and right image are superimposed, that is, occupy all the same set of pixels. An increase in D along the + direction of FIG. 5 to a value greater than “0” corresponds to a relative outward displacement of the left image 308 to the left in and/or right image 310 to the right along a direction parallel to the X-axis shown in FIG. 3A with respect to when the left and right image are superimposed. Thus, the scenario of FIG. 3A in which the left image 308 is displaced outwardly toward the left and/or right image 310 displaced outwardly toward the right with respect to a condition in which the left image 308 and right image 310 are superimposed corresponds to a + value of D in FIG. 5. Moreover, the scenario of FIG. 3B corresponds to a larger + value of D. Thus, the scenario indicated in FIGS. 3A and 3B may be represented by two different points along the portion 510 of the curve 502, as indicated.

Accordingly, the image displacement D may be referred to herein as increasing along a first direction, e.g., a positive direction, when the relative displacement outwardly of a left image toward the left and/or right image toward the right increases, which generally corresponds to the portion 510 of curve 502 proceeding from left to right. The image displacement D may be referred to as decreasing along the same first direction when the relative displacement outwardly of a left image toward the left and/or right image toward the right decreases, even if D has a positive value, which corresponds to the portion 512 of curve 502.

Moreover, the image displacement D may be referred to herein as increasing along a second direction, e.g., a negative direction, when the relative displacement of a left image toward the right and/or right image toward the left increases with respect to a condition in which the left image and right image are superimposed, which may correspond to the portion 514 of curve 502 proceeding from left to right. FIG. 5 also depicts one possible point on curve 502 corresponding to the scenario of FIG. 3C in which D has a negative value, that is, the left image 326 is displaced rightwardly and/or the right image 328 is displaced leftwardly with respect to a condition of superimposition of the left and right images. Finally, the image displacement D may be referred to as decreasing along the second direction when the relative displacement outwardly of a left image toward the left and/or right image toward the right decreases, even if D retains a negative value. This situation is generally depicted in the portion 516 of curve 502 proceeding from left to right.

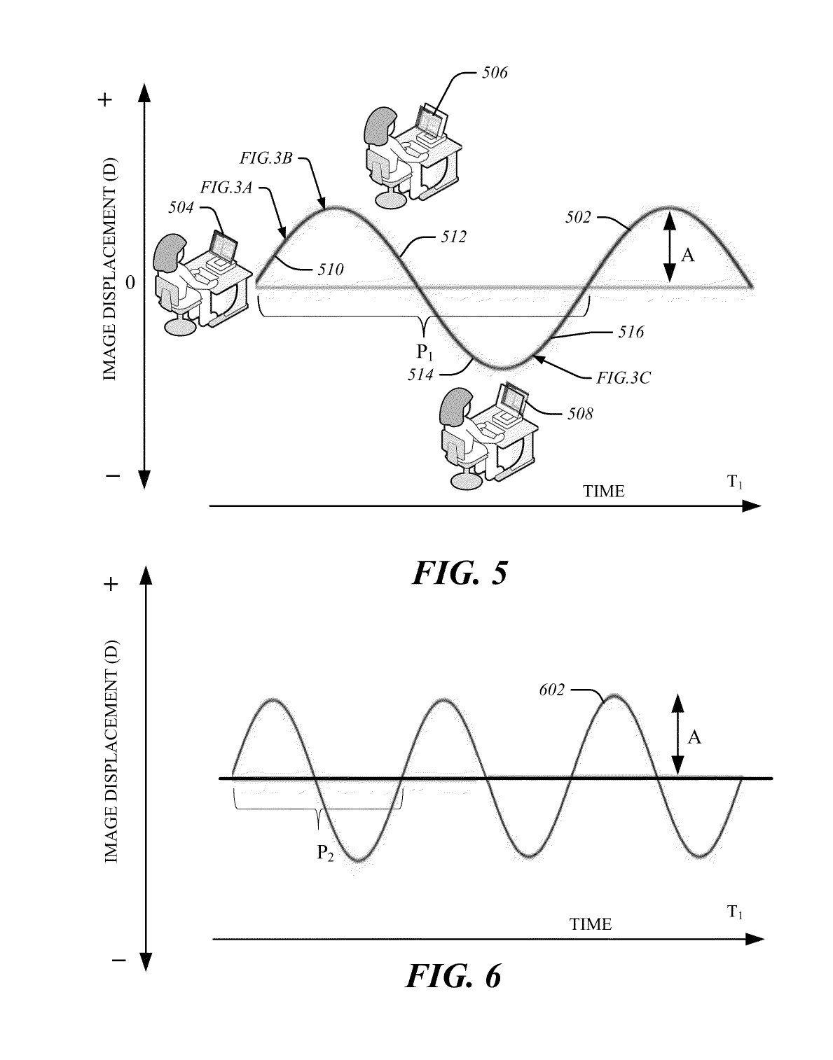

FIG. 6 depicts another exemplary image displacement curve 602 consistent with the present embodiments. In this case, the Amplitude A of maximum change in D is the same as that of image displacement curve 502. However, the period P₂ is shorter than P₁, the period of curve 502. As noted, the period P may be adjusted according to factors including the threshold rate for a user to discern changes in screen depth.

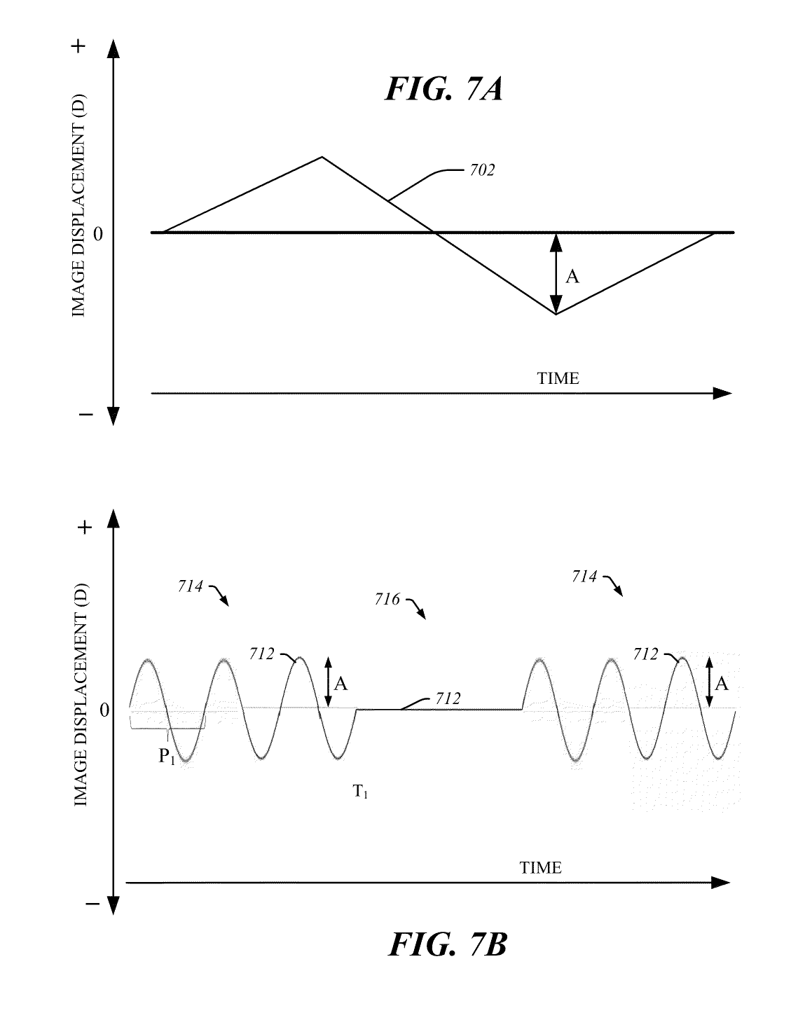

In the examples of FIGS. 5 and 6, the change in image displacement (and screen depth) D may vary in a sinusoidal manner with time. However, in other examples, image displacement D may vary linearly with time. FIG. 7A depicts an image displacement curve 702 that has a linear sawtooth pattern for variation in screen depth D. In this example, as the direction of image displacement D varies, the absolute value of the rate of change of D remains the same as a function of time.

In still further embodiments, value of D may be held constant for periods of time rather than continuously varying. FIG. 7B illustrates one embodiment in which an image displacement curve 712 exhibits intervals 714 in which the image displacement D varies, and intervals 716 in which the image displacement does not vary. In the example of FIG. 7B (as well as FIGS. 5-7A), the illustrated image displacement curve 712 may represent a portion of a larger curve that repeats the same pattern illustrated. As shown, during the intervals 716, the image displacement D is zero. The image displacement curve 712 may be used for example, if it is determined that it is preferable to a user to view a display in which user eyes are focused at a constant depth for discrete intervals. The length of intervals 714 and 716 may be empirically determined by a user to optimize the viewing experience.

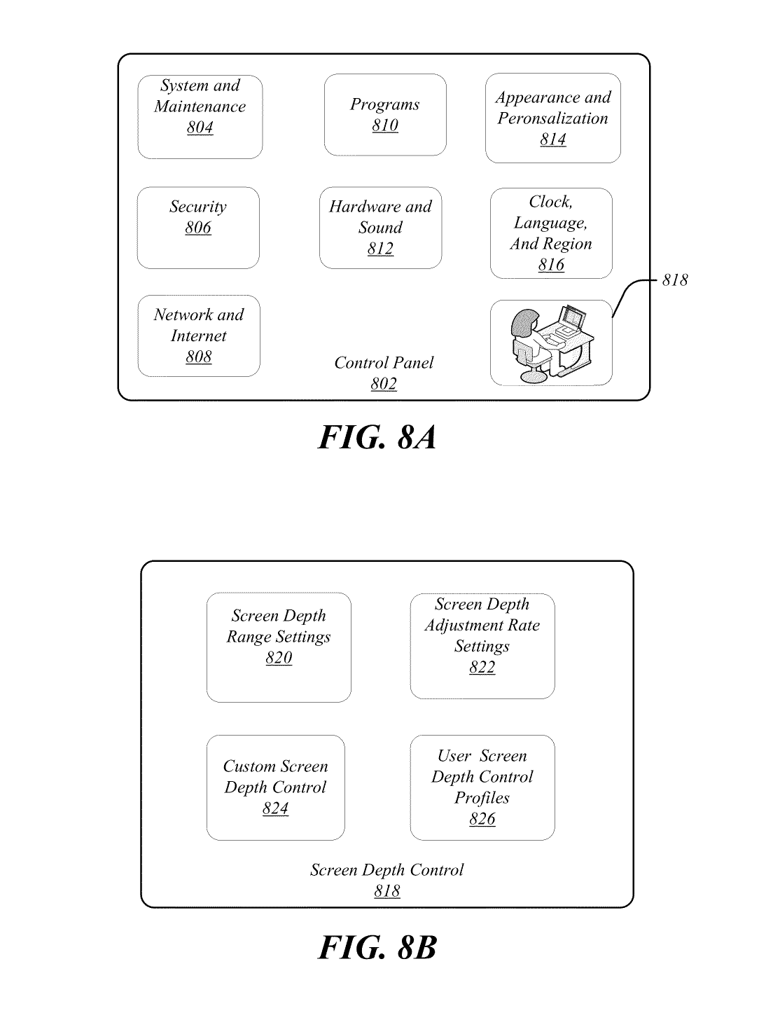

In various embodiments, user control of screen depth in a 3-D display system may be facilitated via a user interface provided in an application or operating system installed on a 3-D display apparatus such as a computer. FIG. 8A depicts an exemplary “control panel” menu 802 that provides a menu to adjust various settings in a computing device. The items 804-816 represent conventional options that may be provided to a computer user to adjust settings. The control panel menu 802 also includes a screen depth control item 818, which when selected provides adjustable features that allow a user to control screen depth as generally described above with respect to FIGS. 4-7B. A shown in FIG. 8B, the screen depth control item 818 includes screen depth range settings selection 820, screen depth adjustment rate selection 822, custom screen depth control selection 824, and user screen depth control profiles selection 826. When chosen, the screen depth range settings selection 820 may allow a user to adjust the value of D as discussed above. When chosen, the screen depth adjustment rate selection 822 may allow a user to adjust the rate of change of screen depth SD (or D) as discussed above. The custom screen depth control selection 824 may allow a user to choose a function or to generate manually a custom curve for varying screen depth. As generally illustrated in respective FIGS. 5-7A, the user may choose a sinusoidal function or a function that generates a linear change in image displacement with time, such as a sawtooth function. Alternatively, the user may generate a more complex curve as illustrated, for example, in the FIG. 7B.

The user screen depth control profiles selection 826 allows a user to store one or more profiles, which each may contain an image displacement curve, such as those illustrated in FIGS. 5a-7B. The image displacement curve may be selected or generated by a user in some instances. Thus, when a first user is to user an apparatus having a 3-D display, the user may engage the user screen depth control profiles selection 826 to load a desired image displacement curve. Since multiple users may use the same apparatus, multiple different profiles may be stored for selection, so that different individuals can adjust the screen depth behavior of a 3-D display as desired according to a prestored profile.

In some instances, once a profile is selected in the user screen depth control profiles selection 826, that profile may remain active to control 3-D display behavior until changes are subsequently entered by a user engaging the user screen depth control profiles selection 826.

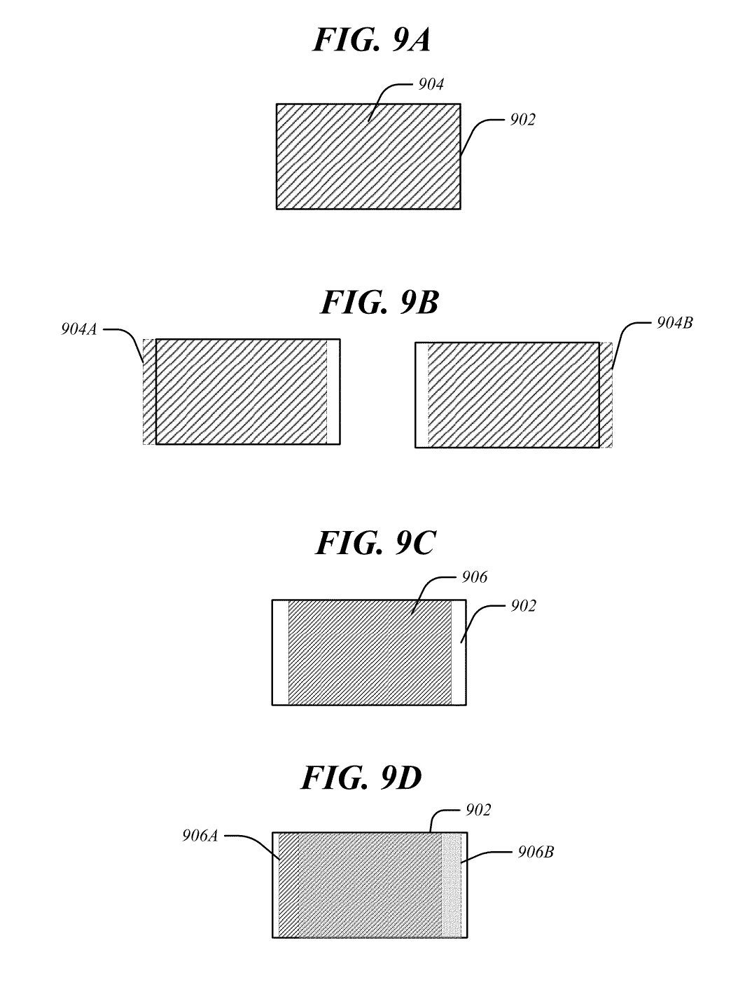

It is to be noted that according to the embodiments described hereinabove, maximum image displacement D between a left image and a right image may correspond to a displacement of up to one hundred pixels or more in some 3-D displays. Accordingly, in various embodiments this image displacement may be accounted for in order that pixels of an image are not “lost” at the left and right extremes of a display. FIGS. 9A-9D illustrate one example of image adjustment to account for the image displacement D. In FIG. 9A there is shown an example in which an image 904 is presented on a 3-D display 902 at a conventional resolution. In the example of FIG. 9A, there is no image displacement between left and right images. FIG. 9B depicts the situation in which in order to vary the screen depth, the left image 904A may be displaced outwardly to the left and right image 904B may displaced outwardly to the right. However, outer portions of each of the left image 904A and right image 904B may not map onto the 3-D display 902 in this instance.

In order to address this situation, the horizontal resolution of images to be presented on the display 902 may be reduced to accommodate shifting of left and right images. FIG. 9C illustrates an adjusted image 906 that is configured to allow shifting of left and right images outwardly in a manner that allows outer portions of each of left image 906A and right image 906B to be presented on the display, as shown in FIG. 9D. In this case, the horizontal resolution is reduced so that at a maximum relative displacement of left image 906A and right image 906B pixels are present on the display 902 to present the left and right images in full.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

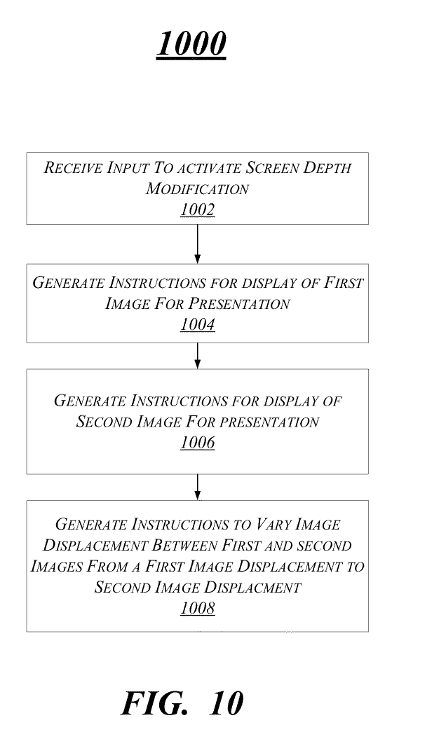

FIG. 10 depicts an exemplary first logic flow 1000. At block 1002 input is received to activate screen depth modification. In one example the input may be received in an apparatus containing a 3-D display to generate the screen depth modification.

At block 1004, instructions are generated for display of a first image to be displayed on a 3-D display. The first image may be a left image for each of one or more rendered frames in some examples, which may be stored in a first frame buffer.

At block 1006 instructions are generated for display of a second image to be displayed on the 3-D display. The second image may be a right image for each of the one or more rendered frames, which may be stored in a second frame buffer.

At block 1008, instructions are generated to vary image displacement between first and second images, from a first image displacement to a second image displacement. In some cases, the first image displacement may be zero.

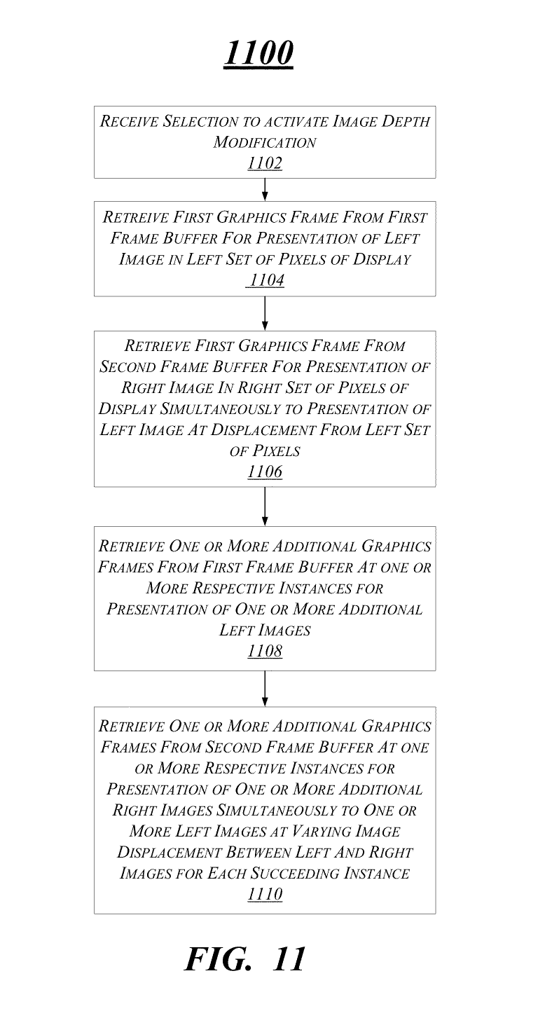

FIG. 11 depicts an exemplary second logic flow. At block 1102, a selection is received to activate screen depth modification. At block 1104, a first graphics frame is retrieved from a first frame buffer for presentation of a left image in a left set of pixels of a display. At block 1106, the first graphics frame is retrieved from a second frame buffer for presentation of a right image in a right set of pixels of the display simultaneously to the presentation of the left image at a displacement from the left set of pixels.

At block 1108, one or more additional graphics frames are retrieved from the first frame buffer at one or more instances for presentation of one or more additional left images. At block 1110, the one or more additional graphics frames are retrieved from the second frame buffer at the one or more respective instances for presentation of one or more additional right images simultaneously to the respective one or more left images at varying image displacement between left and right images for each succeeding instance.

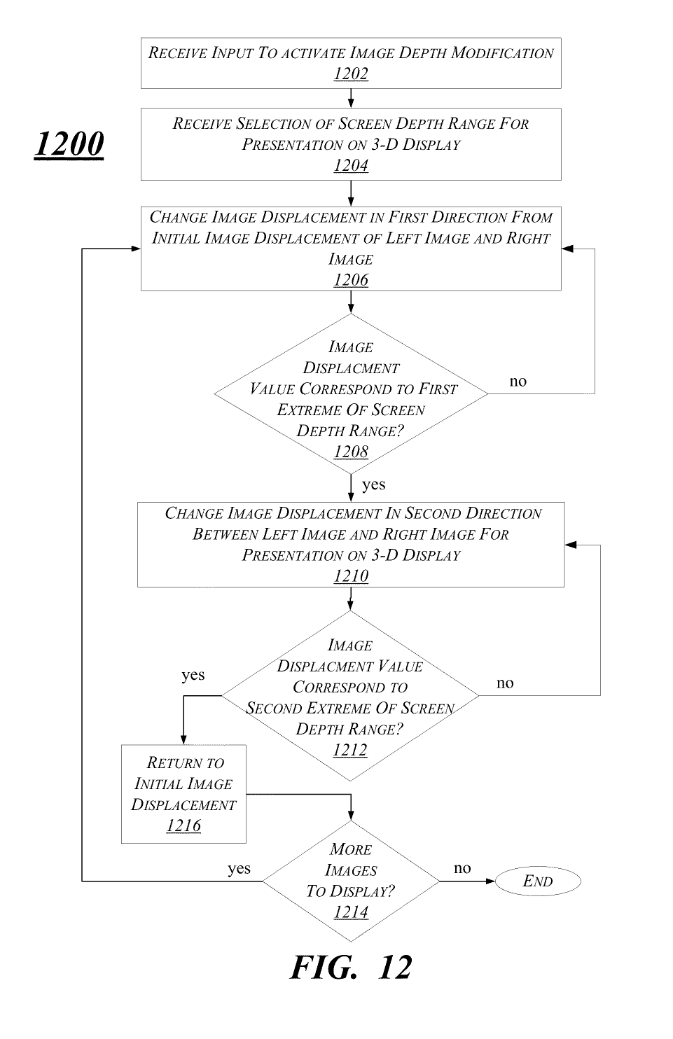

FIG. 12 depicts an exemplary third logic flow. At block 1202, input is received to activate image depth modification. At block 1204 a selection of screen depth range is received for presentation on a 3-D display. At block 1206, the image displacement between left and right images is changed along a first direction from an initial image displacement between left and right images. In some embodiments, the image displacement may vary according to a sinusoidal change with time. In other embodiments, the image displacement may vary linearly with time.

At block 1208 a determination is made as to whether an image displacement value corresponds to a first extreme of a screen depth range. If not, the flow returns to block 1206. If so, the flow proceeds to block 1210.

At block 1210 the image displacement between left and right images is varied along a second direction for presentation on a 3-D display. The second direction may be opposite to the first direction.

At block 1212 a determination is made as to whether an image displacement value corresponds to a second extreme of the screen depth range. If not, the flow returns to block 1210. If so, the flow proceeds to block 1214.

At block 1214 a determination is made as to whether there are more images to display. If not, the flow ends. If so, the flow proceeds to block 1216 where the image displacement is returned to the initial image displacement. Subsequently the flow returns to block 1206.

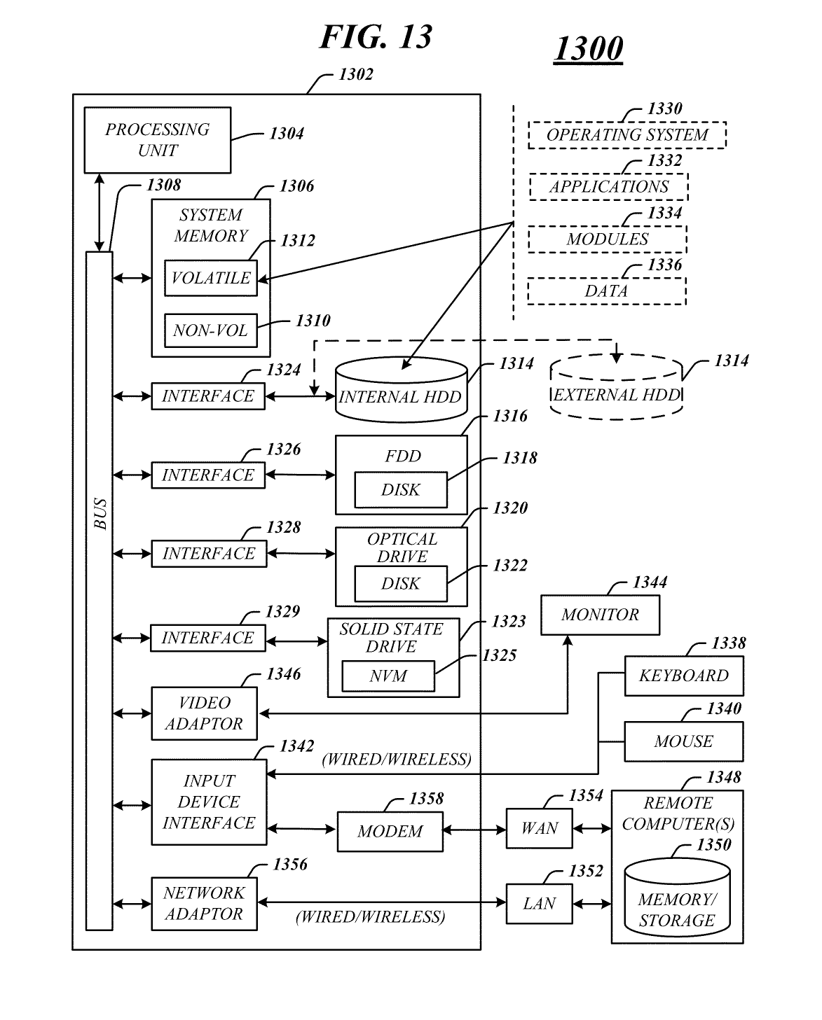

FIG. 13 illustrates an embodiment of an exemplary computing architecture 1300 suitable for implementing various embodiments as previously described. As used in this application, the terms “system” and “component” are intended to refer to a computer-related entity, either hardware, a combination of hardware and software, software, or software in execution, examples of which are provided by the exemplary computing architecture 1300. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, the computing architecture 1300 may include or be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The computing architecture 1300 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 1300.

As shown in FIG. 13, the computing architecture 1300 includes a processing unit 1304, a system memory 1306 and a system bus 1308. The processing unit 1304 can be any of various commercially available processors. Dual microprocessors and other multi-processor architectures may also be employed as the processing unit 1304. The system bus 1308 provides an interface for system components including, but not limited to, the system memory 1306 to the processing unit 1304. The system bus 1308 can be any of several types of bus structure that may further interconnect to a memory bus (with or without a memory controller), a peripheral bus, and a local bus using any of a variety of commercially available bus architectures.

The computing architecture 1300 may include or implement various articles of manufacture. An article of manufacture may include a computer-readable storage medium to store logic. Embodiments may also be at least partly implemented as instructions contained in or on a non-transitory computer-readable medium, which may be read and executed by one or more processors to enable performance of the operations described herein. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like.

The system memory 1306 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 13, the system memory 1306 can include non-volatile memory 1310 and/or volatile memory 1312. A basic input/output system (BIOS) can be stored in the non-volatile memory 1310.

The computer 1302 may include various types of computer-readable storage media in the form of one or more lower speed memory units, including an internal hard disk drive (HDD) 1314, a magnetic floppy disk drive (FDD) 1316 to read from or write to a removable magnetic disk 1318, and an optical disk drive 1320 to read from or write to a removable optical disk 1322 (e.g., a CD-ROM or DVD); and a solid state drive (SSD) 1323 to read or write data to/from a non-volatile memory (NVM) 1325, including a NAND flash memory, phase change memory (PCM), a spin memory; phase change memory with switch (PCMS), magnetoresistive random access memory (MRAM), spin memory, nanowire memory, ferroelectric transistor random access memory (FeTRAM). The HDD 1314, FDD 1316, optical disk drive 1320, and solid state drive 1323 can be connected to the system bus 1308 by a HDD interface 1324, an FDD interface 1326, an optical drive interface 1328, and a solid state drive interface 1329, respectively. The HDD interface 1324 for external drive implementations can include at least one or both of Universal Serial Bus (USB) and IEEE 1394 interface technologies. The solid state drive interface 1329 may include any suitable interface for coupling to the host device, such as, for example, but not limited to, a serial advanced technology attachment (SATA) interface, a serial attached SCSI (SAS) interface, a universal serial bus (USB) interface, a peripheral control interface (PCI), or other suitable device interface.

The drives and associated computer-readable media provide volatile and/or nonvolatile storage of data, data structures, computer-executable instructions, and so forth. For example, a number of program modules can be stored in the drives and memory units 1310, 1312, including an operating system 1330, one or more application programs 1332, other program modules 1334, and program data 1336.

A user can enter commands and information into the computer 1302 through one or more wire/wireless input devices, for example, a keyboard 1338 and a pointing device, such as a mouse 1340. Other input devices may include a microphone, an infra-red (IR) remote control, a joystick, a game pad, a stylus pen, touch screen, or the like. These and other input devices are often connected to the processing unit 1304 through an input device interface 1342 that is coupled to the system bus 1308, but can be connected by other interfaces such as a parallel port, IEEE 1394 serial port, a game port, a USB port, an IR interface, and so forth.

A monitor 1344 or other type of display device is also connected to the system bus 1308 via an interface, such as a video adaptor 1346. In addition to the monitor 1344, a computer typically includes other peripheral output devices, such as speakers, printers, and so forth.

The computer 1302 may operate in a networked environment using logical connections via wire and/or wireless communications to one or more remote computers, such as a remote computer 1348. The remote computer 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wire/wireless connectivity to a local area network (LAN) 1352 and/or larger networks, for example, a wide area network (WAN) 1354. Such LAN and WAN networking environments are commonplace in offices and companies, and facilitate enterprise-wide computer networks, such as intranets, all of which may connect to a global communications network, for example, the Internet.

When used in a LAN networking environment, the computer 1302 is connected to the LAN 1352 through a wire and/or wireless communication network interface or adaptor 1356. The adaptor 1356 can facilitate wire and/or wireless communications to the LAN 1352, which may also include a wireless access point disposed thereon for communicating with the wireless functionality of the adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wire and/or wireless device, connects to the system bus 1308 via the input device interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Various embodiments may comprise one or more elements. An element may comprise any structure arranged to perform certain operations. Some elements may be implemented as hardware, firmware, software, or any combination thereof, as desired for a given set of design parameters or performance constraints. Although an embodiment may be described with a limited number of elements in a certain topology by way of example, the embodiment may include more or less elements in alternate topologies as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Furthermore, aspects or elements from different embodiments may be combined. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

In one embodiment, a device may include a processor circuit and a screen depth modifier component that is for execution on the processor circuit to vary an image displacement between a first image and second image for presentation simultaneously with the first image, where the image displacement varies from a first image displacement to a second image displacement different from the first image displacement.

In another embodiment, the first image displacement may be equal to zero and the second image displacement being a non-zero value.

Alternatively, or in addition, in a further embodiment the screen depth modifier component may be for execution on the processor circuit to modify the image displacement according to a predetermined function.

Alternatively, or in addition, in a further embodiment, the predetermined function may be one of: a sinusoidal function and a function that generates a linear change in image displacement with time.

Alternatively, or in addition, in a further embodiment, the second image displacement may be greater than the first image displacement, the image depth modifier component may be for execution on the processor circuit to send instructions to increase the image displacement in a first direction for a first interval between the first image displacement and the second image displacement and to decrease the image displacement in the first direction for a second interval.

Alternatively, or in addition, in a further embodiment the screen depth modifier component may be for execution on the processor circuit to increase the image displacement in a second direction opposite the first direction to a third image displacement for a third interval and decrease the image displacement in the second direction from the third image displacement for a fourth interval.

Alternatively, or in addition, in a further embodiment the device may include an activation component to switch states between an active state in which the image displacement varies with time between the first image displacement and second image displacement, and an inactive state in which image displacement does not change with time.

Alternatively, or in addition, in a further embodiment the activation component may be for execution on the processor circuit to adjust a pixel resolution between a first resolution in the inactive state and a second resolution in the active state, the second resolution being less than the first resolution.

Alternatively, or in addition, in a further embodiment a maximum image displacement may equal about 100 pixels and a maximum average rate of change of image displacement may equal about 2 pixels per second.

Alternatively, or in addition, in a further embodiment the device may include a stereoscopic display including a matrix of pixels to present the first image simultaneously with the second image, the first image being presented in a first set of pixels and the second image being presented in a second set of pixels.

In another embodiment, a computer implemented method may include sending instructions to vary an image displacement between a first image and second image for presentation simultaneously with the first image, the image displacement varying from a first image displacement to a second image displacement different from the first image displacement.

In a further embodiment of the computer implemented method, the first image displacement may equal to zero and the second image displacement may have a non-zero value.

Alternatively, or in addition, in a further embodiment, the computer implemented method may include modifying the image displacement according to a predetermined function.

Alternatively, or in addition, in a further embodiment of the method, the predetermined function may be one of: a sinusoidal function and a function that generates a linear change in image displacement with time.

Alternatively, or in addition, in a further embodiment, the second image displacement may be greater than the first image displacement, where the computer implemented method includes increasing the image displacement in a first direction for a first interval between the first image displacement and the second image displacement, and decreasing the image displacement in the first direction for a second interval.

Alternatively, or in addition, in a further embodiment, the computer implemented method may include increasing the image displacement in a second direction opposite the first direction to a third image displacement for a third interval and decreasing the image displacement in the second direction from the third image displacement for a fourth interval.

Alternatively, or in addition, in a further embodiment, the computer implemented method may include switching states between an active state in which the image displacement varies with time between the first image displacement and second image displacement, and an inactive state in which image displacement does not change with time.

Alternatively, or in addition, in a further embodiment, the computer implemented method may include adjusting a pixel resolution between a first resolution in the inactive state and a second resolution in the active state, the second resolution being less than the first resolution.

Alternatively, or in addition, in a further embodiment of the computer implemented method, a maximum image displacement may equal about 100 pixels and a maximum average rate of change of image displacement may equal about 2 pixels per second.

In a further embodiment, a device may be configured to perform the method of any one of the preceding embodiments.

In another embodiment, at least one machine readable medium may include a plurality of instructions that in response to being executed on a computing device, cause the computing device to carry out a method according to any one of the preceding embodiments.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a computer-readable medium or article which may store an instruction or a set of instructions that, if executed by a computer, may cause the computer to perform a method and/or operations in accordance with the embodiments. Such a computer may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A device, comprising:
a processor circuit; and
a screen depth modifier component for execution on the processor circuit to:
vary an image displacement between a first image and second image for presentation simultaneously with the first image, the image displacement varying from a first image displacement to a second image displacement different from the first image displacement.

2. The device of claim 1, the first image displacement comprising a value equal to zero and the second image displacement comprising a non-zero value.

3. The device of claim 1, the screen depth modifier component for execution on the processor circuit to modify the image displacement according to a predetermined function.

4. The device of claim 3, the predetermined function comprising a sinusoidal function or a function that generates a linear change in image displacement with time.

5. The device of claim 1, the second image displacement having a value greater than a value for the first image displacement, the image depth modifier component for execution on the processor circuit to send instructions to:
increase the image displacement in a first direction for a first interval between the first image displacement and the second image displacement; and
decrease the image displacement in the first direction for a second interval.

6. The device of claim 5, the screen depth modifier component for execution on the processor circuit to send instructions to:
increase the image displacement in a second direction opposite the first direction to a third image displacement for a third interval; and
decrease the image displacement in the second direction from the third image displacement for a fourth interval.

7. The device of claim 1, comprising an activation component to switch states between an active state in which the image displacement varies with time between the first image displacement and second image displacement, and an inactive state in which image displacement does not change with time.

8. The device of claim 7, the activation component for execution on the processor circuit to adjust a pixel resolution between a first resolution in the inactive state and a second resolution in the active state, the second resolution being less than the first resolution.

9. The device of claim 1, a maximum image displacement equaling about 100 pixels, and a maximum average rate of change of image displacement equaling about 4 pixels per second.

10. The device of claim 1, comprising a stereoscopic display comprising a matrix of pixels to present the first image simultaneously with the second image, the first image presented in a first set of pixels and the second image presented in a second set of pixels.

11. At least one computer-readable storage medium comprising instructions that, when executed, cause a system to:
send instructions to vary an image displacement between a first image and second image for presentation simultaneously with the first image, the image displacement varying from a first image displacement to a second image displacement different from the first image displacement.

12. The at least one computer-readable storage medium of claim 11, the first image displacement equal to zero and the second image displacement not equal to zero.

13. The at least one computer-readable storage medium of claim 11 comprising instructions that, when executed, cause a system to modify the image displacement according to a predetermined function.

14. The at least one computer-readable storage medium of claim 13, the predetermined function comprising a sinusoidal function or a function that generates a linear change in image displacement with time.

15. The at least one computer-readable storage medium of claim 11 comprising instructions that, when executed, cause a system to:
increase the image displacement in a first direction for a first interval between the first image displacement and the second image displacement; and
decrease the image displacement in the first direction for a second interval.

16. The at least one computer-readable storage medium of claim 15 comprising instructions that, when executed, cause a system to:
increase the image displacement in a second direction opposite the first direction to a third image displacement for a third interval; and
decrease the image displacement in the second direction from the third image displacement for a fourth interval.

17. The at least one computer-readable storage medium of claim 11 comprising instructions that, when executed, cause a system to switch states between an active state in which the image displacement varies with time between the first image displacement and second image displacement, and an inactive state in which image displacement does not change with time.

18. The at least one computer-readable storage medium of claim 17 comprising instructions that, when executed, cause a system to adjust a pixel resolution between a first resolution in the inactive state and a second resolution in the active state, the second resolution being less than the first resolution.

19. The at least one computer-readable storage medium of claim 11, a maximum image displacement equaling about 100 pixels, and a maximum average rate of change of image displacement equaling about 4 pixels per second.

20. A computer implemented method, comprising:
sending instructions to vary an image displacement between a first image and second image for presentation simultaneously with the first image, the image displacement varying from a first image displacement to a second image displacement different from the first image displacement.

21. The computer implemented method of claim 20, the first image displacement equal to zero and the second image displacement comprising a non-zero value.

22. The computer implemented method of claim 20, comprising modifying the image displacement according to a predetermined function.

23. The computer implemented method of claim 22, the predetermined function comprising a sinusoidal function or a function that generates a linear change in image displacement with time.

24. The computer implemented method of claim 20, the second image displacement being greater than the first image displacement, the method comprising:
increasing the image displacement in a first direction for a first interval between the first image displacement and the second image displacement; and
decreasing the image displacement in the first direction for a second interval.

25. The computer implemented method of claim 24, comprising:
increasing the image displacement in a second direction opposite the first direction to a third image displacement for a third interval; and
decreasing the image displacement in the second direction from the third image displacement for a fourth interval.

26. The computer implemented method of claim 20, comprising switching states between an active state in which the image displacement varies with time between the first image displacement and second image displacement, and an inactive state in which image displacement does not change with time.

27. The computer implemented method of claim 26, comprising adjusting a pixel resolution between a first resolution in the inactive state and a second resolution in the active state, the second resolution being less than the first resolution.

28. The computer implemented method of claim 20, a maximum image displacement equaling about 100 pixels, and a maximum average rate of change of image displacement equaling about 4 pixels per second.
